(19) United States
(12) Patent Application Publication
(10) Pub. No.: US 2019/0022738 A1
(43) Pub. Date: Jan. 24, 2019

(54) Solid Through Riveting Without Pre-Drilled Holes

(71) Applicant: Trinity North American Freight Car, Inc., Dallas, TX (US)

(72) Inventor: Shaun Richmond, Frankfort, IL (US)

(21) Appl. No.: 15/657,634

(22) Filed: Jul. 24, 2017

(51) Int. Cl. B21J 15/20; B21J 15/02; F16B 5/04

(52) U.S. Cl. CPC B21J 15/20; F16B 5/04; B21J 15/025

(57) ABSTRACT

A system includes a first frame and a second frame extending along a plane defined by a first direction and a second direction. The first frame and the second frame define a plurality of first holes and a plurality of second holes. The axial axes of the first holes and the second hoes are oriented in a direction perpendicular to the first direction and the second direction. The system further includes two or more layers of material positioned between the first frame and the second frame. The system further includes a plurality of rods inserted within the first holes and a driver that forces a portion of each of the plurality of rods through the two or more layers of material into the second holes.

### TECHNICAL FIELD

This disclosure generally relates to riveting, and more particularly to riveting without pre-drilled holes.

### BACKGROUND

Railcars are integral to the transportation of goods across the country. Railcars come in many configurations depending on their intended cargo. For example, hopper cars may be used to transport loose bulk commodities, such as coal, ore, and grain. Sheets of metals, such as steel and aluminum, may be fastened together to construct railcars. For example two or more sheets of aluminum may be fastened together to form a side of a hopper car. Rivets are typically used as fasteners. The rivets may be placed through pre-drilled holes through the sheets of aluminum and then riveted to form the fastening heads on either side of the sheets. Existing systems and methods require a time consuming multi-step process of first pre-drilling the rivet holes, placing the rivets inside the holes, and forming the rivet head.

Attempts to remove the step of pre-drilling the rivet holes has failed to provide a satisfactory solution. For example, “self-piercing” rivets do not require a predrilled hole, but do not fully pierce the layers being riveted. Instead only a portion of the layers are pierced, thereby limiting the strength of the rivet in holding the layers together. Thus, self-piercing rivets may be limited to applications where there are fewer layers or in low stress applications.

### SUMMARY

Particular embodiments described herein include a system for riveting two or more layers of material without predrilled holes. According to some embodiments, a system includes a first frame, a second frame, two or more layers of a material, a plurality of rods, and a driver. The first frame extends along a plane defined by a first direction and a second direction. The first frame defines a plurality of first holes. The axial axes of the first holes are oriented in a direction perpendicular to the first direction and the second direction. The second frame extends along a plane defined by the first direction and second direction. The second fame defines a plurality of second holes. The axial axes of the second holes are oriented in a direction perpendicular to the first direction and the second direction. The two or more layers of a material are positioned between the first frame and the second frame. The plurality of rods are configured to be inserted within the first holes defined by the first frame. The driver forces a portion of each of the plurality of rods through the two or more layers of material into the plurality of second holes defined by the second frame. The centers of the plurality of first holes are aligned with centers of the plurality of second holes when the first frame and second frame are compressed against opposite sides of the two or more layers.

In particular embodiments, dimensions of the plurality of first holes defined by the first frame are the same as dimensions of the plurality of second holes defined by the second frame.

In particular embodiments, a depth of the plurality of first holes defined by the first frame in the axial direction exceeds a length of the plurality of rods.

In particular embodiments, the plurality of first holes are arranged in one or more rows in the first and second directions and the plurality of second holes are arranged in one or more rows in the first and second directions in the same manner as the plurality of the first holes.

In particular embodiments, the plurality of rods comprise a material having similar strength as the two or more layers. The portions of the first frame and the second frame proximate the plurality of first holes and plurality of second holes, respectively, comprise material having higher strength than the plurality of rods.

In particular embodiments, the system includes one or more hydraulic presses configured to compress the first frame and the second frame against the opposite sides of the two or more layers of material.

In particular embodiments, the system includes a rivet gun configured to deform the plurality of rods disposed through the two or more layers of material to form heads on either side of the two or more layers of material.

In particular embodiments, the driver is configured to apply force on the plurality of rods inserted within the first holes simultaneously such that each of the plurality of rods is forced through the two or more layers of materials simultaneously.

In particular embodiments, the plurality of rods and the two or more layers of material comprise one or more of a mild steel, brass, copper, and aluminum.

In another embodiment, the disclosure includes a method for riveting without predrilled holes. The method includes positioning two or more layers of material between a first frame and a second frame. The first frame extends along a plane defined by a first direction and a second direction and defines a plurality of first holes. The axial axes of the first holes are oriented in a direction perpendicular to the first direction and the second direction. The second frame extends along a plane defined by the first direction and second direction and defines a plurality of second holes. The axial axes of the second holes are oriented in a direction perpendicular to the first direction and the second direction. The method further includes compressing the two or more layers between the first frame and the second frame. The method further includes placing a plurality of rods within the first holes defined by the first frame. The method further includes forcing a portion of each of the plurality of rods through the two or more layers into the plurality of second holes defined by the second frame.

In particular embodiments, dimensions of the plurality of first holes defined by the first frame are the same as dimensions of the plurality of second holes defined by the second frame.

In particular embodiments, a depth of the plurality of first holes defined by the first frame in the axial direction exceeds a length of the plurality of rods.

In particular embodiments, the plurality of first holes are arranged in one or more rows in the first and second directions and the plurality of second holes are arranged in one or more rows in the first and second directions in the same manner as the plurality of the first holes.

In particular embodiments, the plurality of rods comprise a material having similar strength as the two or more layers of material. The portions of the first frame and the second frame proximate the plurality of first holes and plurality of second holes, respectively, comprise material having higher strength than the plurality of rods.

In particular embodiments, compressing the two layers between the first frame and the second frame includes hydraulically pressing the first frame and the second frame against the opposite sides of the two or more layers of material.

In particular embodiments, the method also includes forming heads on the plurality of rods disposed through the two or more layers of material on either side of the two or more layers of material.

In particular embodiments, the portions of the plurality of rods are forced through the two or more layers into the plurality of second holes defined by the second frame simultaneously.

According to yet another embodiment, the disclosure includes a method including providing a first frame having first hole and a second frame second hole on opposite sides of two or more layers of aluminum. The first frame and second frame comprise a steel. The method further includes aligning a center of the first hole and a center of the second hole. The method further includes compressing the first hole and second hole against the two or more layers of aluminum on opposite sides. The method further includes placing a rod comprising aluminum inside of the first hole. The method further includes applying force to the rod inside the first hole through an opening of the first hole opposite a surface of the two or more layers of material. The first hole exerts a radial force opposing the radial force of the rod. The applied force forces the rod to pierce through the two or more layers of aluminum and inserts a portion of the rod is inserted within the second hole.

In particular embodiments, the method further includes forming heads on the plurality of rods disposed through the two or more layers of material on either side of the two or more layers of aluminum.

In particular embodiments, the method further includes decompressing the first hole and second hole against the two or more layers of aluminum on opposite sides. The method further includes removing the two or more layers of aluminum from between the first frame and the second frame. The method further includes placing an unpierced two or more layers of aluminum between the first and second frames.

As a result, particular embodiments of the present disclosure may provide numerous technical advantages. For example, particular embodiments may simplify the process of riveting by removing the step of predrilling holes through the two or more layers of material to be fastened. The removal of this step may reduce the time to produce a riveted structure, such as a side panel of a hopper car. Additionally, particular embodiments may allow for fastening portions, such as the heads of the rivet, to be formed on both sides of the two or more layers that are fastened together. In this manner, a secure rivet may be formed, even without the predrilling of holes. Particular embodiments of the present disclosure may provide some, none, all, or additional technical advantages.

### BRIEF DESCRIPTION OF THE DRAWINGS

A more complete and thorough understanding of the particular embodiments and advantages thereof may be acquired by referring to the following description taken in conjunction with the accompanying drawings, in which like reference numbers indicate like features, and wherein:

FIG. 1A-1C illustrates an example a riveting process using pre-drilled holes, according to some embodiments;

FIG. 2A and 2B illustrates an example of the process of using a self-piercing rivet, according to some embodiments.

FIG. 3A illustrates an example riveting system at a first stage, according to some embodiments;

FIG. 3B illustrates an example riveting system at a second stage, according to some embodiments;

FIG. 3C illustrates an example riveting system at a third stage, according to some embodiments;

FIG. 4A illustrates a side view of an example multi-rivet riveting system, according to some embodiments;

FIG. 4B illustrates a top view of the example multi-rivet riveting system of FIG. 4A: and

FIG. 5 is a flow diagram illustrating an example method of riveting two or more layers of material, according to some embodiments.

### DETAILED DESCRIPTION

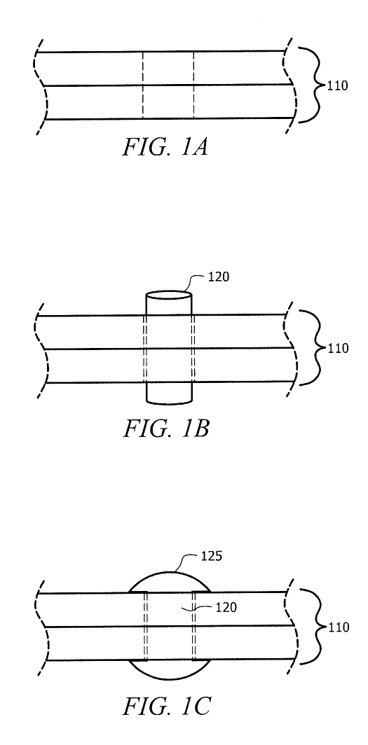

Embodiments of the present disclosure and its advantages are best understood by referring to FIGS. 1 through 5 of the drawings, like numerals being used for like and corresponding parts of the various drawings.

One common railcar is a hopper car which may be used to transport loose bulk commodities such as coal, oil, or in grain. Hopper cars, for example, may be constructed out of sheets of metal which are fastened together. For example, sheets of aluminum may be fastened together with rivets. Riveting multiple layers of aluminum or other materials in conventional construction requires predrilling holes through the sheets of aluminum. After the rivets are placed within the predrilled holes, heads on both sides of the multiple layers of materials may be formed. This multi-step process is an arduous task that requires coordination across the different steps and large amounts of time and man power. For example, the predrilling of the holes requires holes to be drilled at the precise location at which the rivet is to be formed. The drilling apparatus and riveting system are separate and the process usually requires manual placement of the hole locations and rivets within the holes. As a result, the process is inefficient and may result in non-uniform construction of the fastened layers, such as the sides of hopper cars. “Self-piercing” rivets claim to rivet multiple layers of material without requiring a predrilled hole. “Self-piercing” rivets are not, however, as strong as traditional rivets in that they do not entirely pierce through the layers to be fastened together. For example, the “self-piercing” rivet may only pierce through one or more of the layers to be fastened. In this manner, only one head on one side of the layers to be fastened is formed. Thus, “self-piercing” rivets may come unfastened more easily under higher loads than traditional rivets. In addition, “self-piercing” rivets may require the use of a custom riveting system that may not be applied to large scale application.

What is desired is a system and method for forming the rivet without predrilling holes while maintaining the strength of the traditional rivet. One such process contemplated in the disclosure is forcing a rod, used to form the rivet, through the two or more layers of material without predrilling a hole. Forcing a rod through material of similar strength may cause the rod to deform and fail to pierce through the layers. For example, the force translated to the rod by a driver may be opposed by a force by the layers, thereby causing the rod deform and spread out on top of the two or more layers without piercing through the layers. In certain embodiments, this disclosure provides a solution by maintaining opposing force against the axial forces resulting from the rod being driven against the layers. Accordingly, the force provided by the driver translates in a linear direction perpendicular to the two or more layers, thereby forcing the rod through the layers without significant deformation of the rod. Rivet heads may be formed on either side of the rod on opposite sides of the layers to fasten the layers together. For example, frames with one or more holes may be provided such that the frames are compressed against the opposite sides of the two or more layers and the rods are placed within the holes and driven through the layers. The frame portions defining the holes may provide the opposing axial force to prevent the rod from deforming or moving in directions other than through the two or more layers. In this manner, a system and method of riveting may be provided which obviates the need for predrilled holes, thus reducing both the time and resources required to rivet materials together, such as materials used to construct hopper cars.

FIGS. 1A through 1C illustrates an example of an existing riveting process at three stages. FIG. 1A illustrates two or more layers 110 that are to be fastened together. For example, two or more layers 110 may be fastened together to form a side of a hopper car or other portion of a rail car. For example, in certain embodiments two or more layers 110 may include two layers, or in other embodiments may include three, four, five, six, or seven layers of aluminum sheets or any sheets of ductile metal. As shown in FIG. 1A, a hole has been drilled through two or more layers 110 to allow a rivet to be formed through two or more layers 110.

FIG. 1B illustrates an example rivet 120 disposed through the predrilled hole in two or more layers 110. In certain embodiments, rivet 120 is placed into the predrilled hole manually, or alternatively, in certain embodiments, rivet 120 is placed automatically. Rivet 120 may be any rivet that may form fastening portions on either side of two or more layers 110. For example, rivet 120 may be a solid rivet or a blind rivet typically used in the construction of railcars. In conventional riveting systems, rivet 120 may have already have a head formed on one end prior to being inserted (not depicted).

FIG. 1C shows two or more layers 110 having been successfully fastened together with rivet 120 forming fastening portions 125 on opposite sides of two or more layers 110. Fastening portions 125 may be formed using any conventional method based on the type of rivet 120 used. FIGS. 1A through 1C illustrate the typical riveting process. As described above, this process requires predrilling holes for each rivet and placing each rivet individually into those holes. The process requires an precise coordination and time-consuming steps that are not easily automated. Such disadvantages may scale with the number of rivets required. For example, hopper car sides requiring dozens of rivets may increase the inefficiency of the conventional process.

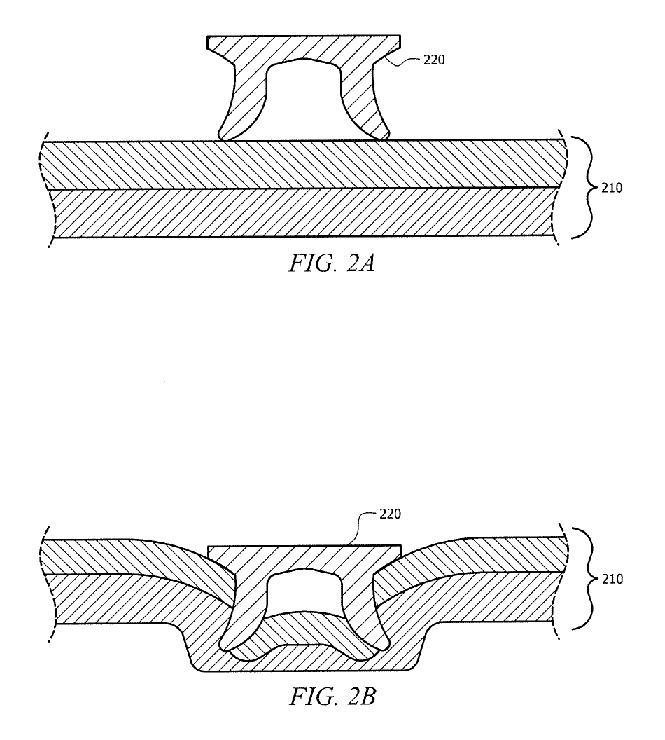

FIG. 2A and FIG. 2B illustrate an example of the process of using a “self-piercing” rivet according to some embodiments. FIG. 2A illustrates a “self-piercing” rivet 220 disposed above two or more layers 210 that are to be fastened by “self-piercing” rivet 220. As shown in FIG. 2A, a predrilled hole is not required for a “self-piercing” rivet.

FIG. 2B illustrates a “self-piercing” rivet after the two or more layers 210 have been riveted with “self-piercing” rivet 220. As illustrated, “self-piercing” rivet 220 pierces through the top layer of two or more layers 210 but does not pierce all the way through the bottom layer of two or more layers 210. In this manner, only one rivet head of “self-piercing” rivet 220 is exposed. As discussed above, this type of rivet may fail to fasten two or more layers 210 together securely under high load. Furthermore, these rivets may require specialized equipment to fasten the layers, which may not be scalable for applications on the scale of railcar sides. Thus, even though “self-piercing” rivet 220 may not require predrilled holes, a better solution for riveting without predrilled holes is desired. In particular, a solid-through rivet disposed through the two or more layers is desired to provide a more secure fasten.

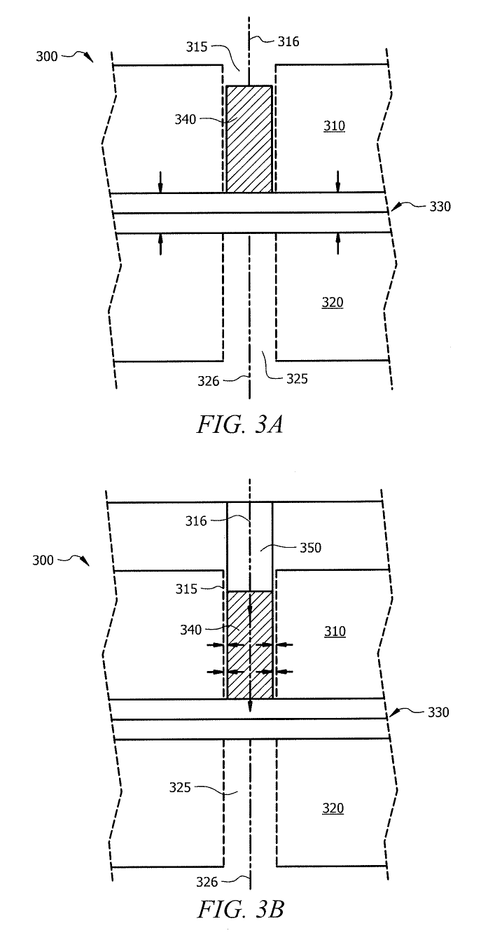

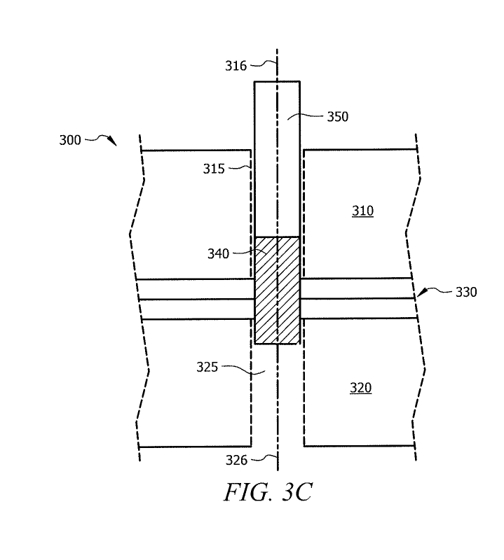

FIG. 3A illustrates an example riveting system 300 during a first stage of the process, according to certain embodiments. Riveting system 300 comprises a first frame 310, a second frame 320, two or more layers 330, and a rod 340. First frame 310 may define a first hole 315 in which rod 340 may be inserted. Similarly, second frame 320 may define a second hole 325. First hole 315 and second hole 325 may be defined such that the centers of first hole 315 and second hole 325 are aligned when first frame 310 and second frame 320 are compressed against opposite sides of two or more layers 330.

In certain embodiments, first hole 315 has first axial axis 316 and second hole 325 has second axial axis 326. First axial axis 316 of first hole 315 may be oriented in a direction perpendicular to the plane defined by first frame 310. Similarly, second axial axis 326 of second hole 325 may be oriented in a direction perpendicular to the plane defined by second frame 320. In this manner, when first frame 310 and second frame 320 are compressed on opposite sides of two or more layers 330, first axial axis 316 and second axial axis 326 may be generally aligned in the same direction. By orienting the axial axes 316 and 326 along the same direction, a straight path for rod 340 may be defined from first hole 315 to second hole 325 through two or more layers 330 when centers of each of first hole 315 and second hole 325 are aligned.

FIG. 3B illustrates riveting system 300 during a second stage of the process, according to certain embodiments. During the second stage illustrated in FIG. 3B, a driver 350 operates to force rod 340 downward towards two or more layers 330 within first hole 315. For example, driver 350 may be any suitable mechanism such as a hydraulic press or a portion thereof to force rod 340 downward. In another example, driver 350 may comprise a hammer blow, including one or more of a manual hammering process or an automatic “drop-hammer.”

When subject to a downward force from driver 350, rod 340 experiences forces attempting to counteract that force thereon. For example, an opposing force at the portion of rod 340 contacting driver 350 may resist the force of driver 350. Force from driver 350 may be translated into a downward force towards two or more layers 330 and also into axial forces in rod 340 towards walls of first hole 315. In certain embodiments, frame 310 and frame 320 comprise materials stronger than rod 340. For example, rod 340 may comprise aluminum and frame 310 may comprise steel in certain embodiments. Because frame 310 comprises a material stronger than rod 340, defined first hole 315 in frame 310 does not deform or give when subject to axial force exerted by rod 340. Instead, the walls of first hole 315 counteracts the axial forces, as shown by arrows, of rod 340. In this manner, rod 340 may follow the path of least resistance, namely, downward towards two or more layers 330.

In certain embodiments, first frame 310 and second frame 320 may be compressed against two or more layers 330 using compressing means such as a hydraulic press or similar system. For example, a hydraulic press may force first frame 310 and second frame 320 against opposite sides of two or more layers 330. In this manner, the resistive force of rod 340 will not move first frame 310 or second frame 320 from two or more layers 330. In another example, a screw jack arrangement may be provided to compress first frame 310 and second frame 320 together either alternatively or in addition to another form of press. If these components are separated, rod 340 may be forced through any gap or hole, which may result in rod 340 failing to pierce two or more layers 330 and become deformed. Thus, the compressive force may counteract the large forces caused in driving rod 340 through two or more layers 330 by securely compressing two or more layers 330 between first frame 310 and second frame 320.

FIG. 3C illustrates riveting system 300 at a third stage of the process, according to certain embodiments. After driver 350 has applied a force sufficient to overcome the piercing threshold of two or more layers 330, rod 340 may be disposed through two or more layers 330 such that a portion of rod 340 is disposed within second hole 325. By placing frame 320 opposite of two or more layers 330 with second hole 325 aligned with first hole 315, rod 340 may maintain a straight trajectory through two or more layers 330. Additionally, the configuration may allow a slug of two or more layers 330, which is punched out by rod 340, to fall through second hole 325 to be removed from the riveted two or more layers 330 or reused in some cases.

Once rod 340 is disposed through two or more layers 330, a head forming tool may be used to form heads on either side of rod 340. For example, the heads may be formed by the usual process as described above in reference to FIG. 1C. In certain embodiments, a rivet gun may be used to form heads on rod 340. In certain embodiments, a rivet compression tool may be used to deform rod 340 to form heads on either side of two or more layers 330. In this manner, rod 340 may securely fasten two or more layers 330. Unlike “self-piercing” rivets, the rivet formed by riveting system 300 disposed rod 340 entirely through two or more layers 330, allowing the formation of fastening heads on both sides of the materials. This results in a stronger fasten that may resist higher shear forces. Additionally, because the drilling of holes is not required, the process is simplified and may be easily automated and result in more uniform riveting.

FIGS. 3A through 3C illustrate riveting system 300 only placing a single rod 340 through two or more layers 330. While only describing a single pair of holes 315 and 325 opposite the two or more layers 330, any number of holes may be so defined within first frame 310 and second frame 320. For example, a plurality of holes may be defined in each of first from 310 and second frame 320. The plurality of holes may define a pattern that corresponds to a desired riveting pattern for a particular purpose. For example, the frames may define holes based on a particular riveting pattern for a hopper side wall.

In certain embodiments, the frames may define holes for general riveting patterns. For example, the pattern of riveting may be defined by the placement of the rods within the plurality of holes. Thus, a general grid of holes may be defined to allow for a number of different patterns that may be desired.

In certain embodiments, driver 350 may be any suitable driving mechanism that may force rod 340 through two or more layers 330. For example, driver 350 may comprise a press, such as a hydraulic press, to provide the force to rod 340. In some embodiments, driver 350 may be configured to drive rod 340 through two or more layers 330 in an isolated process such that driver 350 only drives a single rod, e.g., rod 340, at a particular time. In other embodiments, driver 350 may be configured to drive multiple rods, including rod 340, through two or more layers 330 at the same time. For example, driver 350 may comprise a large plate driven by a hydraulic press that is configured to provide the driving force to the multiple rods simultaneously. As illustrated in example riveting system 300, a portion of driver 350 may be inserted into first hole 315 to force rod 340 through two or more layers 330. By placing rod 340 fully within first hole 315, rod 340 is fully surrounded, thereby preventing rod 340 from moving in any non-desired direction. For example, the portion of driver 350 inserted within first hole 315 may fully cover the top of first hole 315. In this manner, rod 340 may not escape through any gap between driver 350 and the walls of first hole 315.

Rod 340 may comprise any suitable material for forming rivets, including but not limited to any ductile material. In certain embodiments, rod 340 comprises one or more of a mild steel, brass, copper, and aluminum. The material of rod 340 may be chosen based on a variety of criteria, including the type of layers to be fastened, the application of the fastened layers, the materials of the layers, the types of rivet heads to be formed, etc. Rod 340 may comprise material of similar strength to that of two or more layers 330. For example, in certain embodiments, both rod 340 and two or more layers 330 may comprise aluminum. In another example, rod 340 may comprise a material dissimilar to two or more layers 330. Riveting system 300 may allow rod 340 to be pierce two or more layers 330 despite comprising materials of similar or the same strength as described above.

In certain embodiments, first frame 310 and second frame 320 may comprise a material stronger than the material used in rod 340. For example, if rod 340 comprises aluminum, first frame 310 may comprise a steel. In this manner, first frame 310 and second frame 320 may counteract the high forces caused by driving rod 340 through two or more layers 330. Furthermore, by using a more durable material, first frame 310 and second frame 320 may be used many times without significant deformation.

In certain embodiments, first hole 315 and second hole 325 have the same dimensions. For example, first hole 315 and second hole 325 may have the same cross section and same depth as defined in their respective frames. In certain embodiments, first hole 315 and second hole 325 have the same cross section, but have different depths through their respective frames. For example, first frame 310 may be dimensioned larger in the direction perpendicular to two or more layers 330 than the second frame 320 such that first hole 315 has a larger depth than second hole 325.

In certain embodiments, first hole 315 and second hole 325 may have dimensions similar to rod 340. For example, first hole 315 and second hole 325 may be defined to have a cross section matching, or slightly larger than, the cross section of rod 340 such that rod 340 may fit within each of first hole 315 and second hole 325 without much room for movement. In this manner, the walls of first hole 315 may better counteract the axial forces of rod 340 when driven, and prevent significant deformation. Similarly, the walls of second hole 325 may easily receive rod 340 through two or more layers 330 and maintain the shape of rod 340 as it pushes through two or more layers 330. In this manner, rod 340 may be disposed through two or more layers 330 while maintaining its shape so that the rivet heads may be formed.

Rod 340 may be any suitable shape or size for forming rivets fastening two or more layers 330. As illustrated in FIGS. 3A through 3C, rod 340 is cylindrical in certain embodiments. In certain embodiments, rod 340 may have a cross section different from a circular cross section, such as a square or rectangular cross section. Additionally, rod 340 may have a cross section that varies over a length of rod 340. For example, rod 340 may have a taper on one or more ends of rod 340.

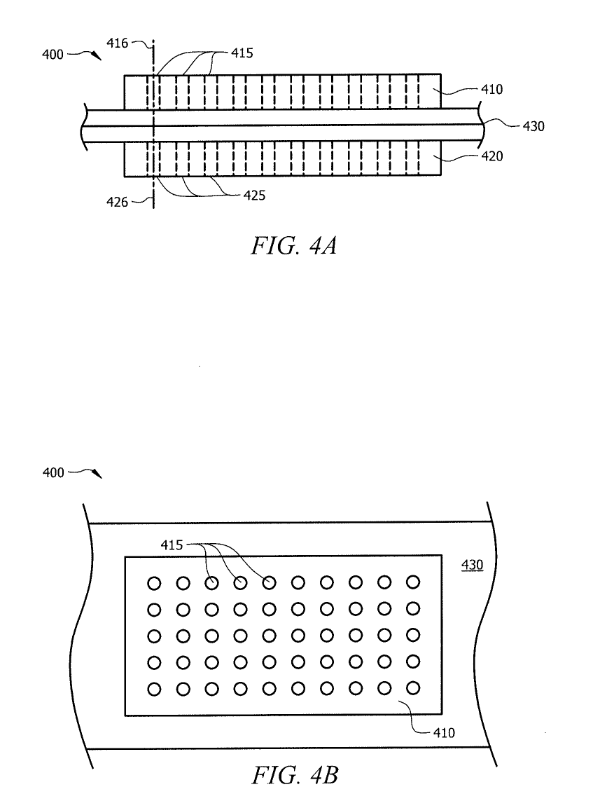

FIG. 4A illustrates a side-view of example riveting system 400, according to certain embodiments. Riveting system 400 includes a plurality of first holes 415 defined by first frame 410 and a corresponding number of second holes 425 in second frame 420. As with example riveting system 300, first frame 410 and second frame 420 of riveting system 400 are disposed on opposite sides of two or more layers 430. FIG. 4B illustrates a top view of riveting system 400 illustrating the first holes 415 defined by first frame 410 from the top.

In certain embodiments, first frame 410 and second frame 420 may both extend along a plane defined by a first direction and a second direction. For example, first frame 410 and second frame 420 may extend in the plane parallel to the plane defined by two or more layers 430. In some embodiments, first axial axes 416 of first holes 415 and second axial axes 426 of second holes 425 are oriented in a direction perpendicular to the first direction and the second direction. For example, first axial axes 416 and second axial axes 426 may extend perpendicular to two or more layers 430.

Riveting system 400 may also include a plurality of rods configured to be inserted within first holes 415 defined by first frame 410. For example, a rod may be entered into each of first holes 415 to be disposed through two or more layers 430 in a similar manner described in reference to FIGS. 3A through 3C. Riveting system 400 may also include a driver configured to force a portion of each of the plurality of rods through two or more layers 430. In this manner, a plurality of rods may be forced through two or more layers 430 in a short period of time. For example, in certain embodiments, a plurality of rods may be disposed through two or more layers 430 simultaneously, such that a driver forces each of the rods through two or more layers 430 at the same time. In certain embodiments, the driver may be a hydraulic press having inserted portions that insert within each of first holes 415 to force rods through two or more layers 430.

In certain embodiments, a plurality of first holes 415 and a plurality of second holes 425 have the same shape and size. As discussed previously, it may be desirable to have the diameter of plurality of second holes 425 match the diameter of first holes 415 such that the rods continue to push through two or more layers 430 after they pierce through two or more layers 430. Likewise, it may be desirable to have first frame 410 and second frame 420 have the same size and shape such that they may be interchangeable or may be adaptable for different orientations without moving riveting system 400 in relation to two or more layers 430.

In certain embodiments, the size of plurality of first holes 415 is different from the size of plurality of second holes 425. For example, if plurality of first holes 415 is the initial position in which rods reside before riveting, plurality of second holes 425 may have a larger diameter than the diameter of plurality of first holes. As an example, plurality of second holes 425 may have a diameter larger by one to four thousandths of an inch. The differences in diameter on this scale would not impede the advantages of having similarly sized holes on either side of two or more layers 430, while at the same time decrease possible resistance of punching out the material of two more layers 430 through plurality of second holes 425.

In certain embodiments, a depth of the plurality of first holes 415 exceeds a length of the plurality of rods. For example, when inserted, the rods may leave room at the top of frame 410 in which a driver may be inserted into the plurality of holes 415. In this manner, the driver may effectively provide force to the rods in order push through two or more layers 430.

In certain embodiments, plurality of first holes 415 are arranged in one or more rows in the first and second directions and a plurality of holes 425 are arranged in one or more rows in the first and second directions in the same manner as the plurality of the first holes. For example, riveting system 400 illustrates an embodiment where plurality of first holes and a plurality of second holes 425 are arranged in rows. In certain embodiments, different configurations of the first holes 415 and second holes 425 may be contemplated. For example, first holes 415 and second holes 425 may be arranged in a perimeter such that it extends along the perimeter of first frame 410 and second frame 420. In other embodiments, other patterns matching the desired riveting pattern to fasten together two or more layers 430. In certain embodiments, a grid of first holes 415 and second holes 425 may be defined such that the riveting pattern may be defined by an operator based on into which holes rods are placed.

In certain embodiments, the plurality of rods comprise a material having similar strength as the two or more layers of material and portions of first frame 410 and second frame 420 comprise material having higher strength than the plurality of rods. Typically, rivets are comprised of a softer material such as aluminum. Similarly, two or more layers 430 in construction of certain rail cars, such as hopper cars, may also comprise aluminum. In this manner, rivets in two or more layers 430 may be comprised of similar materials. As discussed previously, forcing a material through two or more layers of a material having similar strength may cause the forced material, such as a rod, to be deformed and fail to pierce the two or more layers 430. However, by providing first frame 410 and second frame 420 having material stronger than the plurality rods it may counter any axial forces in conjunction with the driver may force the rod through two or more layers 430. In this manner, a rod may pierce through two or more layers 430 even though it has a similar strength as the two or more layers without predrilling holes.

In certain embodiments, riveting system 400 may comprise a hydraulic press. The hydraulic press may be configured to compress frames 410 and 420 against opposite sides of two or more layers 430. In this manner, first frames 410 and second frames 420 may maintain compression when the plurality of rods are forced through two or more layers 430. In other embodiments, there may be a second hydraulic press which presses a plurality of rods through two or more layers 430 using a driver. For example, a hydraulic press may be used to force a plurality of rods through two or more layers 430 simultaneously such that rivets may be made in an efficient manner.

In certain embodiments, riveting system 400 may also comprise a riveting device configured to deform the plurality rods disposed through two or more layers 430 to form heads on either side in order to fasten two or more layers 430. In one example, riveting device may be disposed adjacent to riveting system 400 such that, after the plurality of rods are disposed through two or more layers 430, two or more layers 430 may be moved to the riveting device. Riveting device may then form the heads from the plurality of rods disposed through two or more layers 430. In this manner, the heads may securely fasten two or more layers 430 together. In some embodiments, the riveting device may be interchangeable with first frame 410 and second frame 420 such that two or more layers 430 may remain stationary during the entire riveting process.

In certain embodiments, different materials may be used for various components. In certain embodiments, two or more layers comprise aluminum layers to be fastened together in a plurality of rods comprised aluminum. In certain embodiments, first frame 410 and second frame 420 comprise steel. In this manner, the stronger steel may allow the aluminum rod to pierce through the similarly strength aluminum two or more layers 430. In this manner, the cheaper and lighter aluminum may be used instead of requiring steel or other heavier metals and more expensive metals or alloys to be used.

While FIG. 4B depicts the defined holes of frames 310, 320, 410, and/or 420 as round or circular, the defined holes may additionally or alternatively be defined to have a non-circular cross-section. For example, holes defined by frames 310, 320, 410, and/or 420 may comprise a cross-section different from a circle, such as a star, triangle, rectangle, or square. In certain embodiments, a circular rod 340 may be deposited within a non-circular hole defined in one of frames 310, 320, 410, and/or 420. Rod 340 may be forced through the non-circular hole. Because rod 340 may have a different cross-section than the defined hole, e.g., a round rod in a star-shaped hole, rod 340 may respond to a compressive force by first expanding to match the cross-section of the defined hole before being forced through the multiple layers. In this manner, the defined hole's shape may define the cross-section of the rivet formed through the multiple layers without having to use a correspondingly shaped rod 340 or pre-drill a complex shape through the multiple layers before inserting the rivet. Providing a non-circular rivet cross-section may aid in the fastening of the multiple layers. For example, the non-circular rivet may prevent the rivet from rotating in response to vibrations or other movement of the layers.

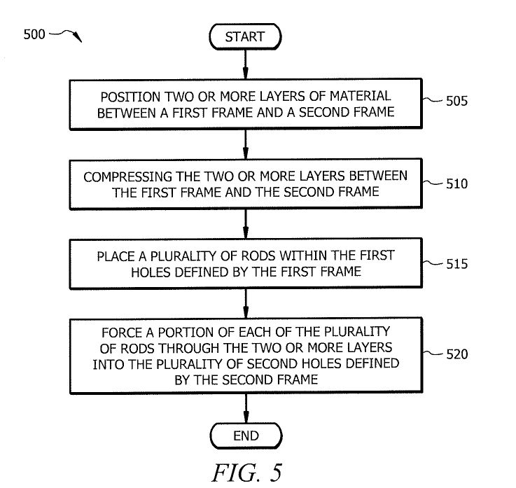

FIG. 5 illustrates a flowchart illustrating an example method 500 of riveting without predrilled holes. Method 500 may begin at step 505. At step 505, two or more layers of material are positioned between a first frame and a second frame. For example, first frame 410 and second frame 420 may be positioned on opposite sides of two or more layers of material 430 such that first holes 415 and second holes 425 are aligned. Once positioned, method 500 may move to step 510. At step 510, the two or more layers are compressed between the first frame and the second frame. For example, a hydraulic press may compress first frame 410 and second frame 420 on opposite sides of two or more layers 430.

Once compressed, a plurality of rods may be placed within the first holes defined by the first frame in step 515. For example, a plurality of aluminum rods may be placed within first holes 415 of frame 410. For example, first frame 410 may be disposed on top of two or more layers 430 such that the plurality of rods may be placed within first holes 415 such that they are in contact with the top layer of two or more layers 430.

At step 520, the plurality of rods may be forced through the two or more layers. A portion of each of the plurality of rods may be forced through two or more layers into the plurality of second holes defined by the second frame. Accordingly, the rods may be disposed through two or more layers with a portion thereof being disposed on either side inside of the first hole and the second hole.

In certain embodiments, method 500 may comprise additional steps. For example, method 500 may include an optional step of riveting the plurality of rods disposed through the two or more layers of material to form heads on either side of the two or more layers of material. In this manner, the heads may form the fastening portions that hold the two or more layers together. In certain embodiments, in step 510 compressing the two or more layers between the first frame and the second frame includes hydraulically pressing the first frame and the second frame against opposite sides of the two or more layers of material.

Modifications, additions, or omissions may be made to method 500 depicted in FIG. 5. Method 500 may include more, fewer, or other steps. For example, steps may be performed in parallel or in any suitable order. While discussed as various components of riveting system 400 performing the steps, any suitable component or combination of riveting system 400 may perform one or more steps of the method.

As a result, particular embodiments of the present disclosure may provide numerous technical advantages. For example, particular embodiments may simplify the process of riveting by removing the step of predrilling holes through the two or more layers of material to be fastened. The removal of this step may reduce the time to produce a riveted structure, such as a side panel of a hopper car. Additionally, particular embodiments may allow for fastening portions, such as the heads of the rivet, to be formed on both sides of the two or more layers that are fastened together. In this manner, a secure rivet may be formed, even without the predrilling of holes. Particular embodiments of the present disclosure may provide some, none, all, or additional technical advantages.

Although certain embodiments have been described in reference to riveting without pre-drilled holes for components or parts of a railcar, systems and methods described herein may be applied to provide solid-through riveting for riveting any suitable structure.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components.

Although embodiments of the present disclosure and their advantages have been described in detail, it should be understood that various changes, substitutions and alternations can be made herein without departing from the spirit and scope of the invention as defined by the claims below.

1. A system, comprising:
a first frame extending along a plane defined by a first direction and a second direction, the first frame defining a plurality of first holes, wherein axial axes of the first holes are oriented in a direction perpendicular to the first direction and the second direction; and
a second frame extending along a plane defined by the first direction and second direction, the second fame defining a plurality of second holes, wherein axial axes of the second holes are oriented in a direction perpendicular to the first direction and the second direction; and
two or more layers of a material positioned between the first frame and the second frame;
a plurality of rods configured to be inserted within the first holes defined by the first frame; and
a driver configured to force a portion of each of the plurality of rods through the two or more layers of material into the plurality of second holes defined by the second frame;
wherein centers of the plurality of first holes are generally aligned with centers of the plurality of second holes when the first frame and the second frame are compressed against opposite sides of the two or more layers.

2. The system of claim 1, wherein dimensions of plurality of first holes defined by the first frame are the same as dimensions of the plurality of second holes defined by the second frame.

3. The system of claim 1, wherein a depth of the plurality of first holes defined by the first frame in the axial direction exceeds a length of the plurality of rods.

4. The system of claim 1, wherein:
the plurality of first holes are arranged in one or more rows in the first and second directions; and
the plurality of second holes are arranged in one or more rows in the first and second directions in the same manner as the plurality of the first holes.

5. The system of claim 1, wherein:
the plurality of rods comprise a material having similar strength as the two or more layers; and
the portions of the first frame and the second frame proximate the plurality of first holes and plurality of second holes, respectively, comprise material having higher strength than the plurality of rods.

6. The system of claim 1, further comprising one or more hydraulic presses configured to compress the first frame and the second frame against the opposite sides of the two or more layers of material.

7. The system of claim 1, further comprising a rivet gun configured to deform the plurality of rods disposed through the two or more layers of material to form heads on either side of the two or more layers of material.

8. The system of claim 1, wherein the driver is configured to apply force on the plurality of rods inserted within the first holes simultaneously such that each of the plurality of rods is forced through the two or more layers of materials simultaneously.

9. The system of claim 1, wherein the plurality of rods and the two or more layers of material comprise one or more of a mild steel, brass, copper, and aluminum.

10. A method, comprising:
positioning two or more layers of material between a first frame and a second frame, wherein:
the first frame extends along a plane defined by a first direction and a second direction and defines a plurality of first holes, wherein axial axes of the first holes are oriented in a direction perpendicular to the first direction and the second direction; and
the second frame extends along a plane defined by the first direction and second direction and defines a plurality of second holes, wherein axial axes of the second holes are oriented in a direction perpendicular to the first direction and the second direction;
compressing the two or more layers between the first frame and the second frame;
placing a plurality of rods within the first holes defined by the first frame; and
forcing a portion of each of the plurality of rods through the two or more layers into the plurality of second holes defined by the second frame;
wherein centers of the plurality of first holes are generally aligned with centers of the plurality of second holes when the first frame and the second frame are compressed against opposite sides of the two or more layers.

11. The method of claim 10, wherein dimensions of the plurality of first holes defined by the first frame are the same as dimensions of the plurality of second holes defined by the second frame.

12. The method of claim 10, wherein a depth of the plurality of first holes defined by the first frame in the axial direction exceeds a length of the plurality of rods.

13. The method of claim 10, wherein:
the plurality of first holes are arranged in one or more rows in the first and second directions;
the plurality of second holes are arranged in one or more rows in the first and second directions in the same manner as the plurality of the first holes.

14. The method of claim 10, wherein:
the plurality of rods comprise a material having similar strength as the two or more layers of material; and
the portions of the first frame and the second frame proximate the plurality of first holes and plurality of second holes, respectively, comprise material having higher strength than the plurality of rods.

15. The method of claim 10, wherein compressing the two layers between the first frame and the second frame comprises hydraulically pressing the first frame and the second frame against the opposite sides of the two or more layers of material.

16. The method of claim 10, further comprising forming heads on the plurality of rods disposed through the two or more layers of material on either side of the two or more layers of material.

17. The method of claim 10, wherein the portions of the plurality of rods are forced through the two or more layers into the plurality of second holes defined by the second frame simultaneously.

18. A method comprising:
providing a first frame having first hole and a second frame second hole on opposite sides of two or more layers of aluminum, wherein the first frame and second frame comprise a steel;
aligning a center of the first hole and a center of the second hole;
compressing the first hole and second hole against the two or more layers of aluminum on opposite sides;
placing a rod comprising aluminum inside of the first hole; and
applying force to the rod inside the first hole through an opening of the first hole opposite a surface of the two or more layers of material;
wherein the first hole exerts a radial force opposing the radial force of the rod and the applied force forces the rod to pierce through the two or more layers of aluminum and inserts a portion of the rod is inserted within the second hole.

19. The method of claim 18, further comprising riveting the plurality of rods disposed through the two or more layers of material to form heads on either side of the two or more layers of aluminum.

20. The method of claim 18, further comprising:
decompressing the first hole and second hole against the two or more layers of aluminum on opposite sides;
removing the two or more layers of aluminum from between the first frame and the second frame; and
placing an unpierced two or more layers of aluminum between the first and second frames.
